(19) United States
(12) Patent Application Publication
(10) Pub. No.: US 2015/0087211 A1
(43) Pub. Date: Mar. 26, 2015

(54) Machine Tool Braking Device

(71) Applicant: Robert Bosch GmbH, Stuttgart (DE)

(72) Inventors: Yunus-Murat Baykara, Esslingen am Neckar (DE); Florian Esenwein, Leinfelden-Echterdingen (DE)

(21) Appl. No.: 14/398,836

(22) PCT Filed: Mar. 11, 2013
(86) PCT No.: PCT/EP2013/054820

§ 371 Date: Nov. 4, 2014

(30) Foreign Application Priority Data
May 4, 2012 (DE) 10 2012 207 451.1
Oct. 5, 2012 (DE) 10 2012 218 197.0

(51) Int. Cl. B24B 47/26; B23Q 11/00; B24B 23/02

(52) U.S. Cl. CPC B24B 47/26; B24B 23/028; B23Q 11/0092
USPC 451/359; 188/74; 188/71.1; 188/72.3

(57) ABSTRACT

A machine tool braking device, particularly a hand-held machine tool braking device, includes at least one braking unit and at least one control unit. The control unit includes a moveably-mounted control element that is configured to activate and/or deactivate the braking unit. The control element has a movement axis and is mounted such that the control element can pivot about the movement axis.

### PRIOR ART

Power tool braking devices, in particular a hand-held power tool braking devices, are already known from EP 2 364 811 A2 and EP 1 938 924 A1, which comprise a braking unit, and comprise an operating unit, having a movably mounted operating element, for activating and/or deactivating the braking unit.

### DISCLOSURE OF THE INVENTION

The invention is based on a power tool braking device, in particular a hand-held power tool braking device, comprising at least one braking unit, and comprising at least one operating unit, having a movably mounted operating element, for activating and/or deactivating the braking unit.

It is proposed that the operating element be mounted such that it can pivot about a movement axis of the operating element. Preferably, the braking unit is realized as a mechanical braking unit. Particularly preferably, the braking unit is realized as a friction brake. It is also conceivable, however, for the braking unit to be of a different design, considered appropriate by persons skilled in the art, such as, for example, designed as a magnetic brake (hysteresis brake, eddy-current brake, etc). The expression “mechanical braking unit” is intended here to define, in particular, a braking unit provided to bring at least one braking element and/or one counter-braking element of the braking unit into a braking position and/or into a release position as a result of a mechanical actuation, in particular as a result of a force of a component being exerted upon the braking element and/or the counter-braking element by a direct contact between the component and the braking element and/or the counter-braking element, in particular in isolation from a magnetic force. “Provided” is to be understood to mean, in particular, specially designed and/or specially equipped. A “braking position” is to be understood here to mean, in particular, a position of the counter-braking element and/or of the braking element in which, for the purpose of reducing a speed of a moving component in a predefined period of time, in particular by at least more than 50%, preferably at least more than 65%, and particularly preferably by at least more than 80%, at least one braking force is exerted upon the moving component, in at least one operating state. In this case, in particular, the predefined period of time is less than 5 s. The term “release position” is intended here to define, in particular, a position of the braking element and/or of the counter-braking element in which an action of the braking force upon the moving component for the purpose of reducing the speed is at least substantially prevented. The braking unit is preferably provided to brake the component, in particular, in a predefined period of time of greater than 0.1 s, preferably greater than 0.5 s, and particularly preferably less than 3 s, starting from a working speed, in particular to a speed that is less than 50% of the working speed, preferably less than 20% of the working speed, and particularly preferably to a speed of 0 m/s.

An “operating unit” is to be understood here to mean, in particular, a unit having at least one component, in particular the operating element, which can be actuated directly by an operator, and which is provided to influence and/or alter a process and/or a state of a unit coupled to the operating unit, through an actuation and/or through an input of parameters. Particularly preferably, the operating unit is provided, in addition to activating and/or in addition to deactivating the braking unit, to enable and/or interrupt an energy supply to a drive unit of a portable power tool provided with the power tool braking device, as a result of an actuation of the operating element. In the case of an activation of the braking unit by means of the operating unit, the braking element and/or the counter-braking element are/is preferably brought into the braking position. In the case of a deactivation of the braking unit by means of the operating unit, the braking element and/or the counter-braking element are/is preferably brought into the release position.

An “operating element” is to be understood to mean, in particular, an element provided to pick up an input quantity from an operator in the case of an operating action, and in particular to be contacted directly by an operator, wherein contacting of the operating element is sensed and/or an actuating force exerted upon the operating element is sensed and/or is transferred mechanically for the purpose of actuating a unit. The expression “mounted such that it can pivot” is intended here to define, in particular, a mounting of the operating element, wherein it is possible for the operating element to move, about at least one axis, by an angle greater than 1°, preferably greater than 5°, and particularly preferably less than 45°. The operating element is preferably realized as a latch element, a so-called paddle switch. A “latch element” is to be understood here to mean, in particular, an operating element that, along a direction of longitudinal extent of the operating element, has a longitudinal extent that is greater than a transverse extent of the operating element that runs at least substantially perpendicularly in relation to the direction of longitudinal extent and runs at least substantially transversely in relation to a direction of movement of the operating element. Preferably, a maximum longitudinal extent of the latch element is at least 2 times greater, preferably at least 2.5 times greater, and particularly preferably at least 3 times greater than a maximum transverse extent of the latch element. The expression “substantially perpendicularly” is intended here to define, in particular, an alignment of a direction relative to a reference direction, wherein the direction and the relative direction, in particular as viewed in one plane, enclose an angle of 90° and the angle has a maximum deviation of, in particular, less than 8°, advantageously less than 5°, and particularly advantageously less than 2°. “At least substantially transversely” is to be understood here to mean, in particular, an alignment of a plane and/or of a direction, relative to a further plane and/or a further direction, that preferably deviates from a parallel alignment of the plane and/or of the direction, relative to the further plane and/or the further direction. The latch element preferably comprises an operating face that, when the latch element is in a mounted state, extends at least over a major part of a maximum transverse extent of a handle housing of a portable power tool. Advantageously, the design of the power tool braking device according to the invention makes it possible to achieve a high degree of operating comfort. In this case, advantageously, owing to the fact that the operating element is mounted such that it can pivot, a small actuating force can be converted into a large positioning force for activating and/or deactivating the braking unit. Moreover, advantageously, owing to the fact that the operating element is mounted such that it can pivot, a biased-off function can be implemented through simple design means. In addition, advantageously, the operating element can be mounted such that it is not susceptible to dirt.

Furthermore, it is proposed that the movement axis of the operating element extend at least substantially transversely in relation to a rotation axis of a rotatably mounted braking element of the braking unit. Preferably, the movement axis extends at least substantially perpendicularly in relation to the rotation axis of the braking element. Preferably, the movement axis of the operating element extends at least substantially parallelwise in relation to a direction of transverse extent of the operating element. The rotation axis of the braking element is preferably coaxial with a rotation axis of a drive shaft of a drive unit, in particular of an electric motor, of a portable power tool. Particularly preferably, the braking element is fixed to the drive shaft in a rotationally fixed manner. It is also conceivable, however, for the braking element to be fixed to a fan propeller of the drive unit by means of a form-fitting and/or adhesive connection. The fan propeller may be realized as a plastic component, as a metallic component and/or as another component considered appropriate by persons skilled in the art. If the fan propeller is designed as a metallic component, it is advantageously possible to prevent a thermal overload caused by a braking force. Moreover, it is likewise conceivable for the braking element to be fixed to another component of the portable power tool such as, for example, a component of a transmission, etc. Particularly, preferably, the braking element is realized as a brake disk. The brake disk is preferably made of high-grade steel and/or of another material, considered appropriate by persons skilled in the art, such as, for example, sintered bronze, steel, nitrided steel, aluminum or another surface-treated steel and/or metal. The counter-braking element is preferably realized as a friction lining, or as a friction lining carrier having friction linings disposed thereon. Advantageously, the design according to the invention makes it possible to achieve a large lever arm for the purpose of actuating the operating element. Thus, advantageously, it is possible to achieve an operating element that can be actuated with a small application of force, such that a high degree of operating comfort can be achieved.

Further, in an alternative design of the power tool braking device, it is proposed that the movement axis of the operating element extend at least substantially parallelwise in relation to a rotation axis of a rotatably mounted braking element of the braking unit. Thus, particularly preferably, the movement axis of the operating element extends at least substantially parallelwise in relation to a direction of longitudinal extent of the operating element. “Substantially parallelwise” is to be understood here to mean, in particular, an alignment of a direction relative to a reference direction, in particular in one plane, the direction deviating from the reference direction by, in particular, less than 8°, advantageously less than 5°, and particularly advantageously less than 2°. Advantageously, the design of the power tool braking device according to the invention enables the pivotally mounted operating element to be operated in an ergonomic manner.

Moreover, it is proposed that the operating unit have at least one movement coupling element for coupling the operating element to a counter-braking element of the braking unit. The term “movement coupling element” is intended here to define, in particular, an element by which two components that are spaced apart from each other, in particular realized so as to be separate from each other, are connected to each other in a movement-dependent manner. Preferably, a force resulting from a movement of the operating element is picked off by means of the movement coupling element and transmitted to at least one component, in particular to the counter-braking element, of the braking unit for the purpose of activating and/or deactivating the braking unit. It is also conceivable, however, for the braking element or the counter-braking element to be disposed directly on the operating element, such that the braking element and/or the counter-braking element are/is brought into a release position or into a braking position as a result of a pivot movement of the operating element about the movement axis of the operating element, without further elements being interposed between the operating element and the braking element or counter-braking element. If the braking element or the counter-braking element is disposed on the operating element, it is conceivable for the braking element or the counter-braking element to be realized, for example, as a drum that surrounds the operating element, at least in a partial region, and that is connected to an armature shaft of the drive unit, and for the braking element or the counter-braking element to be realized as a brake lining that is disposed on the operating element and that, as a result of a pivot movement of the operating element, is pressed on to an inside of the drum or moved away from the latter. Moreover, it is likewise conceivable for the movement coupling element, as a result of being actuated by the operating element, to move a magnet that is provided to move the braking element and/or the counter-braking element, in order to bring the braking unit into a release position and/or into a braking position. The counter-braking element is preferably mounted such that it can pivot about a rotation axis that is coaxial with the rotation axis of the braking element. Moreover, the counter-braking element is preferably mounted such that it can move translationally along the rotation axis of the braking element. Since it is mounted in a pivoting and, in addition, translational manner, the counter-braking element can thus preferably execute a movement on which there is superposed a movement of the counter-braking element that moves rotationally and translationally. In an alternative design of the braking unit, the counter-braking element is mounted so as to be movable only translationally along a movement axis of the counter-braking element that is coaxial with the rotation axis of the braking element. Moreover, in a further, alternative design, it is conceivable for the counter-braking element to be mounted such that it can pivot about a movement axis of the counter-braking element that runs at least substantially transversely in relation to the rotation axis of the braking element. The movement coupling element may be composed of plastic, of metal, of composite material, as a hybrid component, etc. By means of the design of the power tool braking device according to the invention, a movement of the braking element resulting from an actuation of the operating element can be achieved through simple design means.

It is additionally proposed that the operating unit have at least one movement coupling element realized as a cable pull element, for coupling the operating element to a counter-braking element of the braking unit. A “cable pull element” is to be understood here to mean, in particular, an element that can support tensile forces acting upon the element, and that is dissociated from support of compressive forces acting upon the element. In this case, the movement coupling element can in each case be connected directly and/or indirectly to the operating element and the counter-braking element. Advantageously, it is possible to realize a power tool braking device that occupies little space. Moreover, distances between the operating element and the counter-braking element can be spanned through simple design means, wherein a simple deflection can be achieved for guiding the movement coupling element past other components.

In an alternative design of the power tool braking device, the operating unit has at least one movement coupling element realized as a rack element, for coupling the operating element to a counter-braking element of the braking unit. Advantageously, a robust operating unit can be realized. In addition, advantageously, one type of movement can be converted into another type of movement.

In a further alternative design of the power tool braking device, the operating unit has at least one movement coupling element realized as a rotary lever element, for coupling the operating element to a counter-braking element of the braking unit. Advantageously, a lever principle can be used for stepping-up and/or stepping-down actuating forces.

It is furthermore proposed that the operating unit comprise at least one switch-on blocking element, which is connected to a movement coupling element of the operating unit. The term “switch-on blocking element” is intended here to define, in particular, an element provided to lock and/or unlock a movement blocking device of the operating unit. A “movement blocking device” is to be understood here to mean, in particular, a blocking mechanism provided to prevent insofar as possible a movement of a movably mounted component along at least one distance and/or about at least one axis, at least in an operating state, by means of a mechanical, electrical and/or electronic blocking device. Preferably, the movement blocking device is provided to prevent insofar as possible a movement of the movably mounted operating element, at least in an operating state, by means of a mechanical blocking device. It is also conceivable, however, for the movement blocking device to prevent insofar as possible a movement of the operating element, at least in an operating state, by means of an electromagnetic action of force and/or a permanent-magnet action of force, such as, for example, by means of displaceable magnets, upon the operating element. Preferably, the movement blocking device can be unlocked by the switch-on blocking element, to enable the operating element to be moved as a result of an actuation of the operating element. The design according to the invention makes it possible, advantageously, to achieve reliable activation and/or deactivation of the braking unit as a result of an actuation of the switch-on blocking element.

Moreover, it is proposed that the operating unit comprise at least one switch-on blocking element, which is mounted such that it can pivot on the operating element. For the purpose of unlocking the movement blocking device, the switch-on blocking element is preferably mounted such that it can pivot, in at least two mutually differing directions, about a pivot axis of the switch-on blocking element. Preferably, the operating unit comprises at least one spring element, which applies a spring force to the switch-on blocking element in the direction of a central position, in which a movement of the operating element is prevented insofar as possible by means of the movement blocking device. Advantageously, it is possible to achieve comfortable operation of the switch-on blocking element.

The invention is additionally based on a power tool comprising at least one power tool braking device according to the invention. The power tool is preferably realized as a portable power tool. A “portable power tool” is to be understood here to mean, in particular, a power tool, in particular a hand-held power tool, that can be transported by an operator without the use of a transport machine. The portable power tool has, in particular, a mass of less than 50 kg, preferably less than 20 kg, and particularly preferably less than 10 kg. Particularly preferably, the portable power tool is realized as an angle grinder. It is also conceivable, however, for the portable power tool to be of another design considered appropriate by persons skilled in the art, such as, for example, designed as a hand-held planer, as a multifunction power tool, as a portable router, as a sander, and/or as an electrically operated garden appliance. Advantageously, for an operator of the portable power tool, a high degree of operating comfort can be achieved.

The power tool braking device according to the invention and/or the power tool according to the invention are/is not intended in this case to be limited to the application and embodiment described above. In particular, the power tool braking device according to the invention and/or the power tool according to the invention may have individual elements, components and units that differ in number from the number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows a power tool according to the invention, having a power tool braking device according to the invention, in a schematic representation,

FIG. 2 shows a detail view of a braking unit, with the power tool braking device according to the invention in a braking position, in a schematic representation,

FIG. 3 shows the power tool according to the invention with an actuated operating element of an operating unit of the power tool braking device according to the invention, in a schematic representation,

FIG. 4 shows a detail view of the braking unit, with the power tool braking device according to the invention in a release position, in a schematic representation,

FIG. 5 shows an alternative power tool according to the invention, having a power tool braking device according to the invention, in a schematic representation,

FIG. 6 shows a further alternative power tool according to the invention, having a power tool braking device according to the invention, in a schematic representation,

FIG. 7 shows a further alternative power tool according to the invention, having a power tool braking device according to the invention, in a schematic representation,

FIG. 8 shows a further alternative power tool according to the invention, having a power tool braking device according to the invention, in a schematic representation,

FIG. 9 shows a detail view of an alternative actuating mechanism of the operating unit of the power tool braking device according to the invention, in a schematic representation,

FIG. 10 shows a detail view of a further alternative actuating mechanism of the operating unit of the power tool braking device according to the invention, in a schematic representation,

FIG. 11 shows a detail view of a further alternative actuating mechanism of the operating unit of the power tool braking device according to the invention, in a schematic representation,

FIG. 12 shows a detail view of a further alternative actuating mechanism of the operating unit of the power tool braking device according to the invention, in a schematic representation,

FIG. 13 shows a detail view of a further alternative actuating mechanism of the operating unit of the power tool braking device according to the invention, in a schematic representation,

FIG. 14 shows a detail view of a further alternative actuating mechanism of the operating unit of the power tool braking device according to the invention, in a schematic representation,

FIG. 15 shows a detail view of a further alternative actuating mechanism of the operating unit of the power tool braking device according to the invention, in a schematic representation,

FIG. 16 shows a detail view of a braking unit, with a further alternative power tool braking device according to the invention in a braking position, in a schematic representation,

FIG. 17 shows a detail view of the braking unit from FIG. 16 in a release position, in a schematic representation, and

FIG. 18 shows a detail view of a braking unit, with a further alternative power tool braking device according to the invention in a braking position, in a schematic representation.

### DESCRIPTION OF THE EXEMPLARY EMBODIMENTS

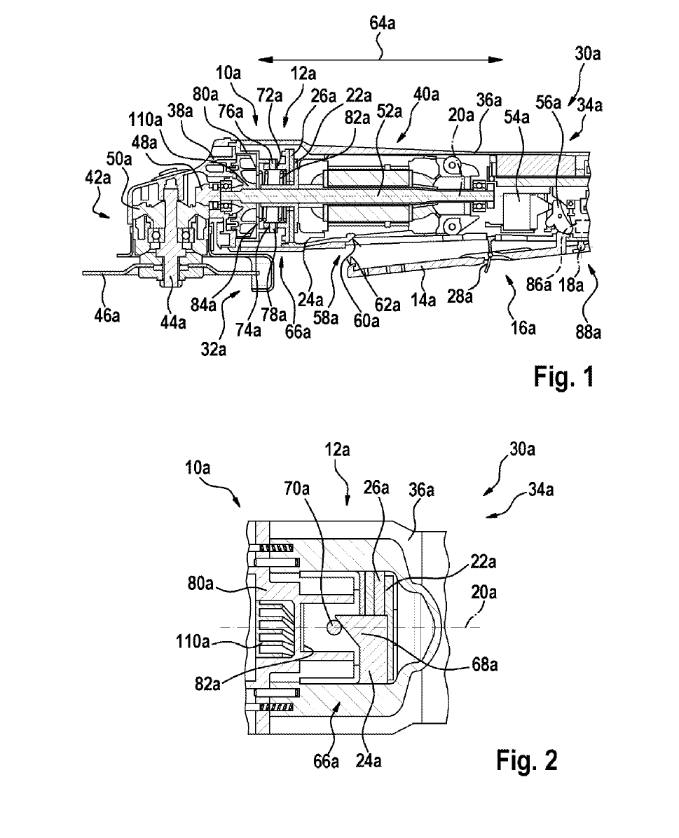

FIG. 1 shows a power tool 30a, realized as a portable power tool, having a power tool braking device 10a. The power tool 30a in this case is realized as an angle grinder. The power tool 30a comprises a protective hood unit 32a and a power tool housing 34a, which encompasses a motor housing 36a and a transmission housing 38a. The motor housing 36a constitutes a main handle that, starting from the transmission housing 38a, extends in a direction away from the transmission housing 38a. Moreover, the motor housing 36a is provided to accommodate and carry a drive unit 40a of the power tool 30a. The drive unit 40a is realized as an electric motor unit. It is also conceivable, however, for the drive unit 40a to be of a different design, considered appropriate by persons skilled in the art, such as, for example, designed as an internal combustion drive unit, as a hybrid drive unit, etc. The transmission housing 38a is provided to accommodate a transmission unit 42a. Extending out of the transmission housing 38a there is a spindle 44a of the transmission unit 42a, to which a working tool 46a, for performing work on a workpiece (not represented in greater detail here) can be fixed. The working tool 46a is realized as a sanding disk. It is also conceivable, however, for the working tool 46a to be realized as a parting or polishing disk. The drive unit 40a is provided to drive the working tool 46a in rotation, via the transmission unit 42a. Via a drive element 48a of the drive unit 40a that can be driven in rotation, the transmission unit 42a is connected, in a manner already known to persons skilled in the art, to a transmission element 50a of the transmission unit 42a that is realized, for example, as a gear wheel such as, for example, a ring gear.

The power tool braking device 10a comprises at least one braking unit 12a, and comprises at least one operating unit 16a, having a movably mounted operating element 14a, for activating and/or deactivating the braking unit 12a. In addition to activating and/or deactivating the braking unit 12a, the operating element 14a is provided to close an electric circuit for the purpose of supplying energy to the drive unit 40a, to enable the power tool 30a to be put into operation. The operating element 14a is provided to close an electric circuit by means of an actuation of an electric switch 54a of the power tool 30a. For this purpose, the operating element 14a has an actuating region that, as a result of a movement of the operating element 14a, actuates a switch actuating element 56a of the operating unit 16a that is movably mounted in the motor housing 36a. The switch actuating element 56a is pivotally mounted in the motor housing 36a. It is also conceivable, however, for the actuating region of the operating element 14a to actuate the switch 54a directly. The operating element 14a is realized as a latch element. The operating element 14a in this case extends, along a direction of main extent 64a of the power tool 30a, over at least 70% of a total extent of the motor housing 36a.

The operating element 14a is mounted such that it can pivot about a movement axis 18a of the operating element 14a. The movement axis 18a of the operating element 14a extends at least substantially transversely in relation to a rotation axis 20a of a rotatably mounted braking element 22a of the braking unit 12a. A pivot bearing region 88a of the operating element 14a in this case is disposed at an end of the operating element 14a that faces away from the transmission housing 38a. The braking unit 12a is realized as a mechanical friction brake unit. The braking element 22a is thus realized as a brake disk. The braking element 22a in this case is fixed on a drive shaft 52a of the drive unit 40a in a rotationally fixed manner by means of a force-closed connection such as, for example, a press fit. The rotation axis 20a of the braking element 22a is thus coaxial with a rotation axis of the drive shaft 52a. Moreover, the rotation axis 20a of the braking element 22a extends at least substantially parallelwise in relation to the direction of main extent 64a. The drive shaft 52a is realized as an armature shaft of the drive unit 40a. The braking element 22a in this case is disposed on the drive shaft 52a, on a side of a fan propeller 110a of the drive unit 40a that faces toward a stator of the drive unit 40a. It is also conceivable, however, for the braking element 22a to be connected to the drive shaft 52a in a rotationally fixed manner by means of a form-closed and/or adhesive connection. Moreover, it is conceivable for the braking element 22a to be disposed in a rotationally fixed manner on the drive shaft 52a, or to be disposed in a rotationally fixed manner on the spindle 44a, at another position considered appropriate by persons skilled in the art.

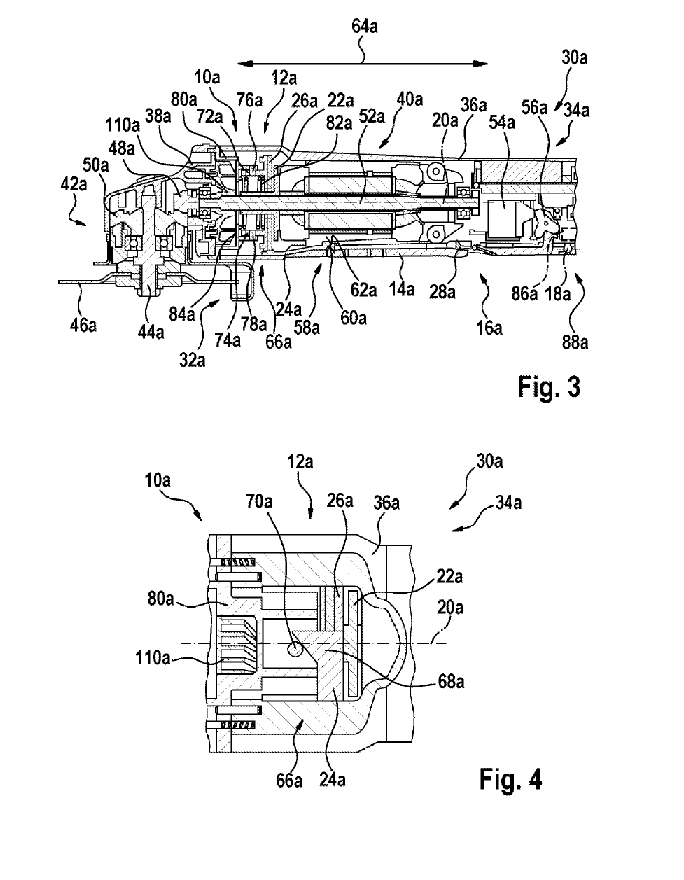

The operating unit 16a additionally has at least one movement coupling element 24a, for coupling the operating element 14a to a counter-braking element 26a of the braking unit 12a. The movement coupling element 24a is mounted in a translationally movable manner in the power tool housing 34a. Moreover, the movement coupling element 24a comprises a coupling region 58a that faces toward the operating element 14a. The coupling region 58a comprises a ramp-type actuating face 60a. The actuating face 60a is provided to act in combination with an inclined face 62a of the operating element 14a that is realized to correspond to the actuating face 60a, as a result of a movement of the operating element 14a in the direction of the power tool housing 34a. As a result of the combined action of the actuating face 60a and the inclined face 62a, the movement coupling element 24a, upon a movement of the operating element 14a in the direction of the power tool housing 34a, is moved translationally in the direction of the transmission housing 38a. As a result of this, the counter-braking element 26a of the braking unit 12a is moved away from the braking element 22a. The braking unit 12a is thus brought into a release position (FIG. 3). It is also conceivable, however, in an alternative design of the power tool braking device 10a, for the movement coupling element 24a to be moved in a direction away from the transmission housing 38a, in order to bring the braking unit 12a into the release position. Moreover, it is conceivable for the operating unit 16a to comprise a spring element, which applies a spring force to the movement coupling element 24a, to enable the movement coupling element 24a to be reset to an initial position after an action of force has been removed.

The movement coupling element 24a has a movement transmission region 66a for the purpose of moving the counter-braking element 26a. The movement transmission region 66a comprises at least one ramp-type actuating element 68a (FIG. 2). The actuating element 68a is provided to act in combination with a coupling extension 70a of the counter-braking element 26a. When the counter-braking element 26a is in a mounted state, the coupling extension 70a extends at least substantially perpendicularly in relation to the rotation axis 20a of the braking element 22a, starting from the counter-braking element 26a. The coupling extension 70a is realized so as to be integral with the counter-braking element 26a. It is also conceivable, however, for the coupling extension 70a to be realized so as to be separate from the counter-braking element 26a, and to be fastened to the counter-braking element 26a by means of at least one fastening element considered appropriate by persons skilled in the art, such as, for example, a rivet, a screw, etc.

The counter-braking element 26a additionally has at least two groove-type recesses 72a, 74a, which extend at least substantially transversely in relation to the rotation axis 20a of the braking element 22a. It is also conceivable, however, for the counter-braking element 26a to be fixed on an additional bearing element of the braking unit 12a, and for the groove-type recesses 72a, 74a to be disposed in the additional bearing element. Moreover, the braking unit 12a comprises at least two pin-type guide elements 76a, 78a, which each engage in one of the recesses 72a, 74a. The groove-type recesses 72a, 74a are disposed on the counter-braking element 26a, offset by approximately 180° relative to each other. The pin-type guide elements 76a, 78a are disposed on a brake carrier element 80a of the braking unit 12a, offset by approximately 180° relative to each other. The groove-type recesses 72a, 74a and the pin-type guide elements 76a, 78a together constitute a cam mechanism of the braking unit 12a. The counter-braking element 26a is mounted so as to be movable relative to the brake carrier element 80a. The brake carrier element 80a is disposed in the power tool housing 34a, solid with the housing.

As a result of a translational movement of the movement coupling element 24a that is caused by the movement of the operating element 14a, the coupling extension 70a slides on a face of the actuating element 68a that faces toward the coupling extension 70a. As a result of this, a combined action of the groove-type recesses 72a, 74a and the pin-type guide elements 76a, 78a causes the counter-braking element 26a to be displaced translationally, wherein a rotation of the counter-braking element 26a is superposed on the translation (FIG. 4). The counter-braking element 26a in this case is moved by the braking element 22a, against a spring force of a spring element 82a of the braking unit 12a, away from the braking element 22a. The spring element 82a is provided to apply a spring force to the counter-braking element 26a in the direction of the braking element 22a. In this case, the spring element 82a is supported with one end on a collar 84a of the brake carrier element 80a and, with a further end, the spring element 82a is supported on the counter-braking element 26a. It can thus be ensured that, after removal of an actuating force, as a result of the spring force of the spring element 82a, the counter-braking element 26a is moved in the direction of the braking element 22a and is pressed on to the latter. The braking unit 12a is thus brought into a braking position.

Furthermore, the operating unit 16a comprises at least one switch-on blocking element 28a, which is mounted such that it can pivot on the operating element 14a. It is also conceivable, however, for the switch-on blocking element 28a to be mounted so as to be translationally movable on the operating element 14a. The switch-on blocking element 28a is provided to prevent insofar as possible an unintentional movement of the operating element 14a in the direction of the power tool housing 34a. The switch-on blocking element 28a is thus provided to prevent, insofar as possible, the power tool 30a being unintentionally put into operation. Furthermore, the operating unit 16a comprises a biased-off device 86a, which is provided to bring the operating element 14a back into an initial position if an action of force is interrupted, or if a minimum actuating force exerted by an operator upon the operating element 14a is not attained. As a result of this, an electric power supply to the drive unit 40a is interrupted, and the braking unit 12a brakes the drive shaft 52a, or the spindle 44a driven in rotation, by means of a combined action of the braking element 22a and of the counter-braking element 26a, and thus brakes the working tool 46a. The biased-off device 86a in this case comprises a spring element (not represented in greater detail here), which is disposed on the pivot bearing region 88a of the operating element 14a, and which applies a spring force to the operating element 14a in the direction of an initial position of the operating element 14a. The spring element of the biased-off device 86a thus acts upon the operating element 14a in a direction away from the power tool housing 34a.

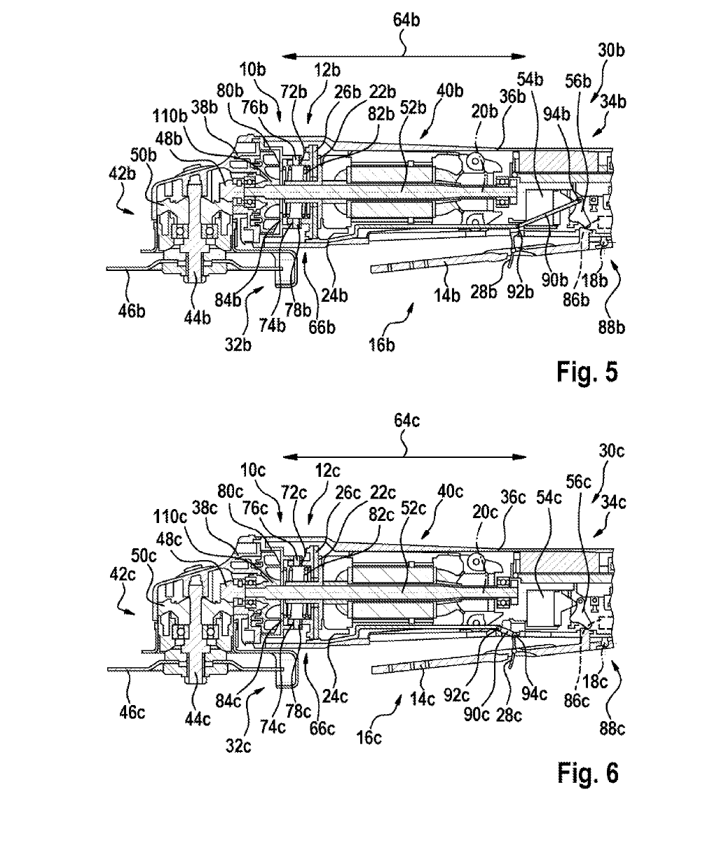

Alternative exemplary embodiments are represented in FIGS. 5 to 18. Components, features and functions that remain substantially the same are denoted by essentially the same references. To differentiate the exemplary embodiments, the letters a to n are appended to the references of the exemplary embodiments. The description that follows is limited essentially to the differences in respect of the first exemplary embodiment, described in FIGS. 1 to 4, and reference may be made to the description of the first exemplary embodiment in FIGS. 1 to 4 in respect of components, features and functions that remain the same.

FIG. 5 shows an alternative power tool 30b, having an alternative power tool braking device 10b. The design of the power tool 30b is at least substantially similar to that of the power tool 30a described in FIGS. 1 to 4. The power tool braking device 10b comprises at least one braking unit 12b, and comprises at least one operating unit 16b, having a movably mounted operating element 14b, for activating and/or deactivating the braking unit 12b. The operating element 14b is mounted such that it can pivot about a movement axis 18b of the operating element 14b. The movement axis 18b extends at least substantially transversely in relation to a rotation axis 20b of a rotatably mounted braking element 22b of the braking unit 12b. A pivot bearing region 88b of the operating element 14b in this case is disposed at an end of the operating element 14b that faces away from a transmission housing 38b of a power tool housing 34b of the power tool 30b.

The operating unit 16b additionally has a switch actuating element 56b, which is movably mounted in a power tool housing 34b of the power tool 30b. The operating element 14b comprises an actuating region, for actuating the switch actuating element 56b. The operating unit 16b has at least one movement coupling element 24b, for coupling the operating element 14b to a counter-braking element 26b of the braking unit 12b. The movement coupling element 24b is mounted in a translationally movable manner in the power tool housing 34b. Moreover, the operating unit 16b comprises a connecting element 90b, which is provided to connect the movement coupling element 24b and the switch actuating element 56b to each other. The connecting element 90b is connected, with one end, to the movement coupling element 24b, via a link element 92b of the operating unit 16b and, with a further end, the connecting element 90b is connected to the switch actuating element 56b, via a further link element 94b of the operating unit 16b. Thus, the operating element 14b, as a result of a movement in the direction of the power tool housing 34b, by means of the switch actuating element 56b and the connecting element 90b, is coupled to the counter-braking element 26b via the movement coupling element 24b. In respect of further functions and features of the power tool braking device 10b and the power tool 30b, reference may be made to the exemplary embodiment described in FIGS. 1 to 4.

FIG. 6 shows an alternative power tool 30c, having an alternative power tool braking device 10c. The design of the power tool 30c is at least substantially similar to that of the power tool 30a described in FIGS. 1 to 4. The power tool braking device 10c comprises at least one braking unit 12c, and comprises at least one operating unit 16c, having a movably mounted operating element 14c, for activating and/or deactivating the braking unit 12c. The operating element 14c is mounted such that it can pivot about a movement axis 18c of the operating element 14c. The movement axis 18c extends at least substantially transversely in relation to a rotation axis 20c of a rotatably mounted braking element 22c of the braking unit 12c. A pivot bearing region 88c of the operating element 14c in this case is disposed at an end of the operating element 14c that faces away from a transmission housing 38c of a power tool housing 34c of the power tool 30c.

The operating unit 16c additionally has at least one switch-on blocking element 28c, which is connected to a movement coupling element 24c of the operating unit 16c. The switch-on blocking element 28c in this case is connected to the movement coupling element 24c by means of a connecting element 90c and at least two link elements 92c, 94c of the operating unit 16c. The braking unit 12c is thus brought from a braking position into a release position by means of an actuation of the switch-on blocking element 28c. Moreover, a movement capability of the operating element 14c, in the direction of the power tool housing 34c, is released as a result of the actuation of the switch-on blocking element 28c. In respect of further functions and features of the power tool braking device 10c and the power tool 30c, reference may be made to the exemplary embodiment described in FIGS. 1 to 4.

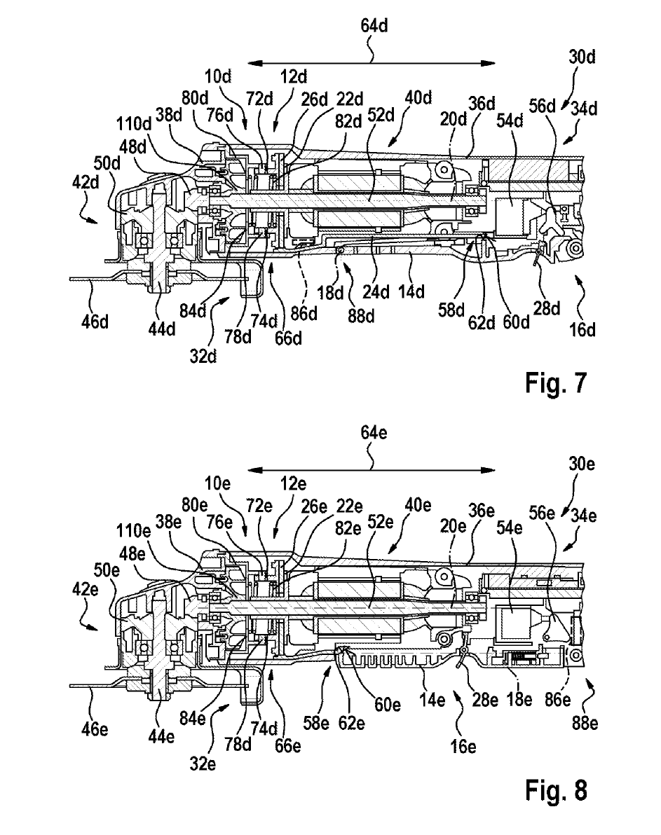

FIG. 7 shows an alternative power tool 30d, having an alternative power tool braking device 10d. The design of the power tool 30d is at least substantially similar to that of the power tool 30a described in FIGS. 1 to 4. The power tool braking device 10d comprises at least one braking unit 12d, and comprises at least one operating unit 16d, having a movably mounted operating element 14d, for activating and/or deactivating the braking unit 12d. The operating element 14d is mounted such that it can pivot about a movement axis 18d of the operating element 14d. The movement axis 18d extends at least substantially transversely in relation to a rotation axis 20d of a rotatably mounted braking element 22d of the braking unit 12d. A pivot bearing region 88d of the operating element 14d in this case is disposed at an end of the operating element 14d that faces toward a transmission housing 38d of a power tool housing 34d of the power tool 30d.

The operating element 14d comprises an inclined face 62d, which is provided to act in combination with an actuating face 60d of a movement coupling element 24d of the operating unit 16d that is realized to correspond to the inclined face 62d, as a result of a movement of the operating element 14d in the direction of the power tool housing 34d. As a result of the combined action of the inclined face 62d and the actuating face 60d, the movement coupling element 24d, mounted so as to be translationally movable, is displaced in the direction of the transmission housing 38d. As a result of this, a counter-braking element 26d of the braking unit 12d is moved away from the braking element 22d, and the braking unit 12d is brought into a release position. It is also conceivable, however, for the braking unit 12d to be motionally connected to the operating unit 16d by another mechanism considered appropriate by persons skilled in the art, as described for example, in FIGS. 5 and 6. In respect of further functions and features of the power tool braking device 10d and the power tool 30d, reference may be made to the exemplary embodiment described in FIGS. 1 to 4.

FIG. 8 shows an alternative power tool 30e, having an alternative power tool braking device 10e. The design of the power tool 30e is at least substantially similar to that of the power tool 30a described in FIGS. 1 to 4. The power tool braking device 10e comprises at least one braking unit 12e, and comprises at least one operating unit 16e, having a movably mounted operating element 14e, for activating and/or deactivating the braking unit 12e. The operating element 14e is mounted such that it can pivot about a movement axis 18e of the operating element 14e. The movement axis 18e extends at least substantially parallelwise in relation to a rotation axis 20e of a rotatably mounted braking element 22e of the braking unit 12e. It is also conceivable, however, for the braking unit 12e to be motionally connected to the operating unit 16e by another mechanism considered appropriate by persons skilled in the art, as described for example, in FIGS. 5 and 6. In respect of further functions and features of the power tool braking device 10e and the power tool 30e, reference may be made to the exemplary embodiment described in FIGS. 1 to 4.

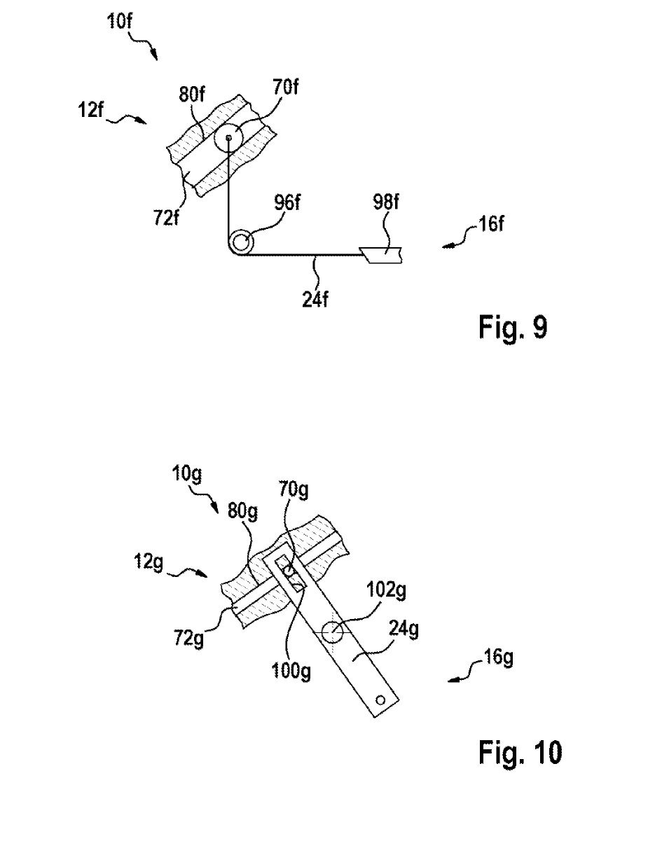

FIG. 9 shows an alternative operating unit 16f of a power tool braking device 10f. The power tool braking device 10f in this case is disposed in a power tool, not represented in greater detail, whose design is at least substantially similar to that of the power tool 30a described in FIGS. 1 to 4. The power tool braking device 10f comprises at least one braking unit 12f, and comprises at least one operating unit 16f, having a movably mounted operating element (not represented in greater detail here), for activating and/or deactivating the braking unit 12f. In this case, the design of the braking unit 12f, or of the operating element, is at least substantially similar to that of the braking unit 12a, or operating element 14a, described in FIGS. 1 to 4. The braking unit 12f thus comprises at least one coupling extension 70f, which is disposed on a counter-braking element (not represented in greater detail here) of the braking unit 12f. In addition, a brake carrier element 80f of the braking unit 12f comprises at least one groove-type recess 72f, in which the coupling extension 70f engages.

The operating unit 16f additionally has at least one movement coupling element 24f, realized as a cable pull element, for coupling the operating element to the counter-braking element of the braking unit 12f. The movement coupling element 24f is connected to the coupling extension 70f and to a ramp element 98f that bears against an inclined face (not represented in greater detail here) of the operating element. The ramp element 98f is mounted so as to be translationally movable. Moreover, the operating unit 16f has a deflection element 96f, realized as a roller. The deflection element 96f is provided to deflect the movement coupling element 24f that is realized as a cable pull element. The movement coupling element 24f thus passes around the deflection element 96f, at least partially. As a result of a movement of the operating element in the direction of a power tool housing (not represented in greater detail here) of the power tool, the ramp element 98f slides on the inclined face, with a face of the ramp element 98f that faces toward the inclined face. As a result of this, the movement coupling element 24f realized as a cable pull element is subjected to a tensile force in a direction away from the braking unit 12f, and is moved in the direction away from the braking unit 12f. As a result of this, the coupling extension 70f slides in the groove-type recess 72f. The counter-braking element in this case executes a translation, on which a rotation is superposed. The counter-braking element is thus moved away from the braking element.

FIG. 10 shows an alternative operating unit 16g of a power tool braking device 10g. The power tool braking device 10g in this case is disposed in a power tool, not represented in greater detail, whose design is at least substantially similar to that of the power tool 30a described in FIGS. 1 to 4. The power tool braking device 10g comprises at least one braking unit 12g, and comprises at least one operating unit 16g, having a movably mounted operating element (not represented in greater detail here), for activating and/or deactivating the braking unit 12g. In this case, the design of the braking unit 12g, or of the operating element, is at least substantially similar to that of the braking unit 12a, or operating element 14a, described in FIGS. 1 to 4. The braking unit 12g thus comprises at least one coupling extension 70g, which is disposed on a counter-braking element (not represented in greater detail here) of the braking unit 12g. In addition, a brake carrier element 80g of the braking unit 12g comprises at least one groove-type recess 72g, in which the coupling extension 70g engages.

The operating unit 16g additionally has at least one movement coupling element 24g, realized as a rotary lever element, for coupling the operating element to the counter-braking element of the braking unit 12g. The movement coupling element 24g realized as a rotary lever element has, at one end, a groove-type receiving recess 100g, in which the coupling extension 70g engages. Moreover, the movement coupling element 24g realized as a rotary lever element is connected, by a further end, to the operating element. As a result of a movement of the operating element in the direction of a power tool housing (not represented in greater detail here) of the power tool, the movement coupling element 24g realized as a rotary lever element is rotated about a rotation axis 102g of the movement coupling element 24g. As a result of this, the coupling extension 70g is moved in the groove-type recess 72g of the brake carrier element 80g. The counter-braking element in this case executes a translation, on which a rotation is superposed. The counter-braking element is thus moved away from the braking element.

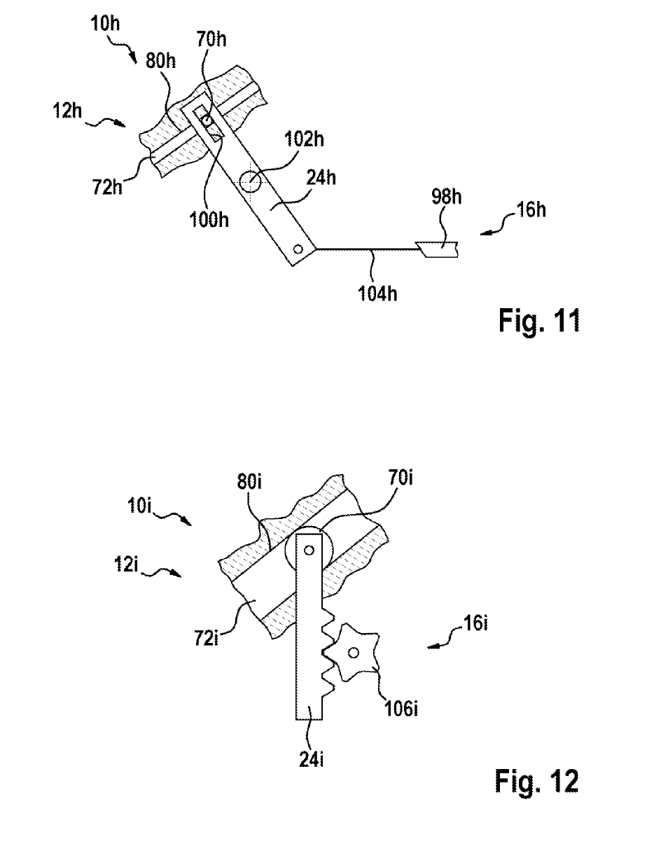

FIG. 11 shows an alternative operating unit 16h of a power tool braking device 10h. The power tool braking device 10h in this case is disposed in a power tool, not represented in greater detail, whose design is at least substantially similar to that of the power tool 30a described in FIGS. 1 to 4. The power tool braking device 10h comprises at least one braking unit 12h, and comprises at least one operating unit 16h, having a movably mounted operating element (not represented in greater detail here), for activating and/or deactivating the braking unit 12h. In this case, the design of the braking unit 12h, or of the operating element, is at least substantially similar to that of the braking unit 12a, or operating element 14a, described in FIGS. 1 to 4. The braking unit 12h thus comprises at least one coupling extension 70h, which is disposed on a counter-braking element (not represented in greater detail here) of the braking unit 12h. In addition, a brake carrier element 80h of the braking unit 12h comprises at least one groove-type recess 72h, in which the coupling extension 70h engages.

The operating unit 16h additionally has at least one movement coupling element 24h, realized as a rotary lever element, for coupling the operating element to the counter-braking element of the braking unit 12h. In addition, the operating unit 16h comprises at least one cable pull element 104h, which is connected to one end of the movement coupling element 24h realized as a rotary lever element. By another end, at which the movement coupling element 24h realized as a rotary lever element has a groove-type receiving recess 100h, the movement coupling element 24h is connected to the coupling extension 70f as a result of the coupling extension 70h engaging in the groove-type receiving recess 100h. The cable pull element 104h is connected to a ramp element 98h that bears against an inclined face (not represented in greater detail here) of the operating element. The ramp element 98h is mounted so as to be translationally movable. As a result of a movement of the operating element in the direction of a power tool housing (not represented in greater detail here) of the power tool, the ramp element 98h slides on the inclined face, with a face of the ramp element 98h that faces toward the inclined face. As a result of this, the cable pull element 104h is subjected to a tensile force in a direction away from the braking unit 12h, and is moved in the direction away from the braking unit 12h. As a result of this, the movement coupling element 24h realized as a rotary lever element is rotated about a rotation axis 102h of the movement coupling element 24g. As a result of this, the coupling extension 70h slides in the groove-type recess 72h of the brake carrier element 80h. The counter-braking element in this case executes a translation, on which a rotation is superposed. The counter-braking element is thus moved away from the braking element.

FIG. 12 shows an alternative operating unit 16i of a power tool braking device 10i. The power tool braking device 10i in this case is disposed in a power tool, not represented in greater detail, whose design is at least substantially similar to that of the power tool 30a described in FIGS. 1 to 4. The power tool braking device 10i comprises at least one braking unit 12i, and comprises at least one operating unit 16i, having a movably mounted operating element (not represented in greater detail here), for activating and/or deactivating the braking unit 12i. In this case, the design of the braking unit 12i, or of the operating element, is at least substantially similar to that of the braking unit 12a, or operating element 14a, described in FIGS. 1 to 4. The braking unit 12i thus comprises at least one coupling extension 70i, which is disposed on a counter-braking element (not represented in greater detail here) of the braking unit 12i. In addition, a brake carrier element 80i of the braking unit 12i comprises at least one groove-type recess 72i, in which the coupling extension 70i engages.

The operating unit 16i additionally has at least one movement coupling element 24i, realized as a rack element, for coupling the operating element to the counter-braking element of the braking unit 12i. The movement coupling element 24i realized as a rack element is mounted in a translationally movable manner in a power tool housing (not represented in greater detail here) of the power tool. Moreover, the operating unit 16i comprises at least one gear wheel element 106i, which is rotatably mounted in the power tool housing. The gear wheel element 106i meshes, on the one hand, with the movement coupling element 24i realized as a rack element and, on the other hand, with a rack (not represented in greater detail here) disposed on the operating element. It is also conceivable, however, for the operating element, as an alternative to having the rack, to have a gear wheel element that is rotatably mounted on the operating element. As a result of a movement of the operating element in the direction of the power tool housing, the rack disposed on the operating element meshes with the gear wheel element 106i. As a result of this, the gear wheel element 106i is put into rotation, and thus moves the movement coupling element 24i realized as a rack element. The counter-braking element in this case executes a translation, on which a rotation is superposed. The counter-braking element is thus moved away from the braking element.

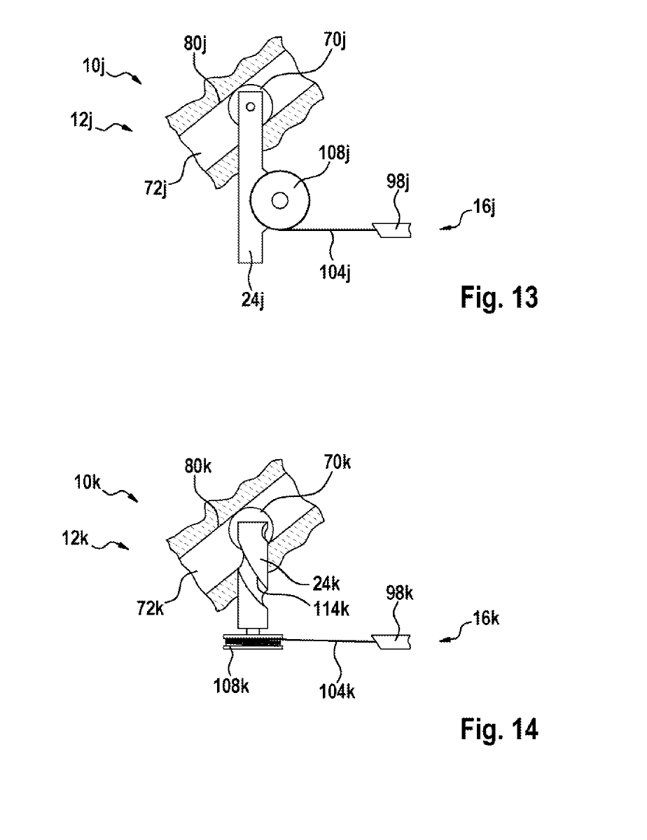

FIG. 13 shows an alternative operating unit 16j of a power tool braking device 10j. The power tool braking device 10j in this case is disposed in a power tool, not represented in greater detail, whose design is at least substantially similar to that of the power tool 30a described in FIGS. 1 to 4. The power tool braking device 10j comprises at least one braking unit 12j, and comprises at least one operating unit 16j, having a movably mounted operating element (not represented in greater detail here), for activating and/or deactivating the braking unit 12j. In this case, the design of the braking unit 12j, or of the operating element, is at least substantially similar to that of the braking unit 12a, or operating element 14a, described in FIGS. 1 to 4. The braking unit 12j thus comprises at least one coupling extension 70j, which is disposed on a counter-braking element (not represented in greater detail here) of the braking unit 12j. In addition, a brake carrier element 80j of the braking unit 12j comprises at least one groove-type recess 72j, in which the coupling extension 70j engages.

The operating unit 16j additionally has at least one movement coupling element 24j, realized as a rack element, for coupling the operating element to the counter-braking element of the braking unit 12j. The movement coupling element 24j realized as a rack element is mounted in a translationally movable manner in a power tool housing (not represented in greater detail here) of the power tool. Moreover, the operating unit 16j comprises at least one gear wheel element (not represented in greater detail here), which is rotatably mounted in the power tool housing. The gear wheel element in this case meshes with the movement coupling element 24j realized as a rack element. The operating unit 16j additionally comprises at least one pulley element 108j, which is connected to the gear wheel element in a rotationally fixed manner. The operating unit 16j additionally comprises at least one cable pull element 104j, which can be rolled up by means of the pulley element 108j. The cable pull element 104j is additionally connected to a ramp element 98j that bears against an inclined face (not represented in greater detail here) of the operating element. The ramp element 98j is mounted so as to be translationally movable. As a result of a movement of the operating element in the direction of a power tool housing (not represented in greater detail here) of the power tool, the ramp element 98j slides on the inclined face, with a face of the ramp element 98j that faces toward the inclined face. As a result of this, the cable pull element 104j is subjected to a tensile force in a direction away from the braking unit 12j, and is moved in the direction away from the braking unit 12j. In this case, the pulley element 108j and the gear wheel element are put into rotation. Moreover, the movement coupling element 24j realized as a rack element is moved as a result of the meshing with the gear wheel element. The counter-braking element in this case executes a translation, on which a rotation is superposed. The counter-braking element is thus moved away from the braking element.

FIG. 14 shows an alternative operating unit 16k of a power tool braking device 10k. The power tool braking device 10k in this case is disposed in a power tool, not represented in greater detail, whose design is at least substantially similar to that of the power tool 30a described in FIGS. 1 to 4. The power tool braking device 10k comprises at least one braking unit 12k, and comprises at least one operating unit 16k, having a movably mounted operating element (not represented in greater detail here), for activating and/or deactivating the braking unit 12k. In this case, the design of the braking unit 12k, or of the operating element, is at least substantially similar to that of the braking unit 12a, or operating element 14a, described in FIGS. 1 to 4. The braking unit 12k thus comprises at least one coupling extension 70k, which is disposed on a counter-braking element (not represented in greater detail here) of the braking unit 12k. In addition, a brake carrier element 80k of the braking unit 12k comprises at least one groove-type recess 72k, in which the coupling extension 70k engages.

The operating unit 16k additionally has at least one movement coupling element 24k, realized as a contour element, for coupling the operating element to the counter-braking element of the braking unit 12k. The movement coupling element 24k realized as a contour element comprises a helix-type recess 114k, in which the coupling extension 70k engages. Moreover, the operating unit 16k comprises at least one pulley element 108k, on which a cable pull element 104k of the operating unit 16k can be rolled up. The movement coupling element 24k, realized as a contour element, and the pulley element 108k are rotatably mounted in a power tool housing (not represented in greater detail here) of the power tool. The cable pull element 104k is connected to a ramp element 98k that bears against an inclined face (not represented in greater detail here) of the operating element. The ramp element 98k is mounted so as to be translationally movable. As a result of a movement of the operating element in the direction of a power tool housing, the ramp element 98k slides on the inclined face, with a face of the ramp element 98k that faces toward the inclined face. As a result of this, the cable pull element 104k is subjected to a tensile force in a direction away from the braking unit 12k, and is moved in the direction away from the braking unit 12k. In this case, the pulley element 108k and the movement coupling element 24k realized as a contour element are put into rotation. The coupling extension 70k slides in the helix-type recess 114k of the movement coupling element 24k realized as a contour element, as a result of which the counter-braking element executes a translation, on which a rotation is superposed. The counter-braking element is thus moved away from the braking element.

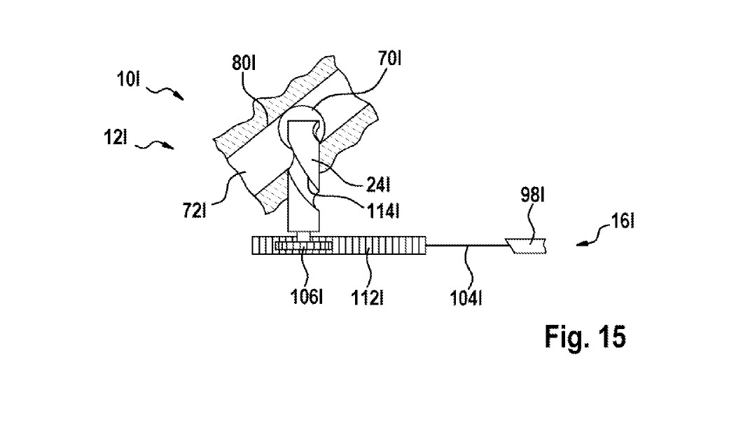

FIG. 15 shows an alternative operating unit 16l of a power tool braking device 10l. The power tool braking device 10l in this case is disposed in a power tool, not represented in greater detail, whose design is at least substantially similar to that of the power tool 30a described in FIGS. 1 to 4. The power tool braking device 10l comprises at least one braking unit 12l, and comprises at least one operating unit 16l, having a movably mounted operating element (not represented in greater detail here), for activating and/or deactivating the braking unit 12l. In this case, the design of the braking unit 12l, or of the operating element, is at least substantially similar to that of the braking unit 12a, or operating element 14a, described in FIGS. 1 to 4. The braking unit 12l thus comprises at least one coupling extension 70l, which is disposed on a counter-braking element (not represented in greater detail here) of the braking unit 12l. In addition, a brake carrier element 80l of the braking unit 12l comprises at least one groove-type recess 72l, in which the coupling extension 70l engages.

The operating unit 16l additionally has at least one movement coupling element 24l, realized as a contour element, for coupling the operating element to the counter-braking element of the braking unit 12l. The movement coupling element 24l realized as a contour element comprises a helix-type recess 114l, in which the coupling extension 70l engages. Moreover, the operating unit 16l comprises at least one gear wheel element 106l, which is connected in a rotationally fixed manner to the movement coupling element 24l realized as a contour element. The gear wheel element 106l and the movement coupling element 24l realized as a contour element are rotatably mounted in a power tool housing (not represented in greater detail here) of the power tool. The operating unit 16l additionally comprises at least one rack element 1121 and at least one cable pull element 104l. The rack element 1121 in this case is translationally mounted in the power tool housing. The gear wheel element 106l meshes with the rack element 1121. The cable pull element 104l is connected to a ramp element 98l that bears against an inclined face (not represented in greater detail here) of the operating element. The ramp element 98l is mounted so as to be translationally movable. As a result of a movement of the operating element in the direction of a power tool housing, the ramp element 98l slides on the inclined face, with a face of the ramp element 98l that faces toward the inclined face. As a result of this, the cable pull element 104l is subjected to a tensile force in a direction away from the braking unit 12l, and is moved in the direction away from the braking unit 12l. In this case, the rack element 1121 is moved translationally, and the gear wheel element 106l is put into rotation. As a result of this, the movement coupling element 24l, connected in a rotationally fixed manner to the gear wheel element 106l and realized as a contour element, is likewise put into rotation. The coupling extension 70k slides in the helix-type recess of the movement coupling element 24l realized as a contour element, as a result of which the counter-braking element executes a translation, on which a rotation is superposed. The counter-braking element is thus moved away from the braking element.

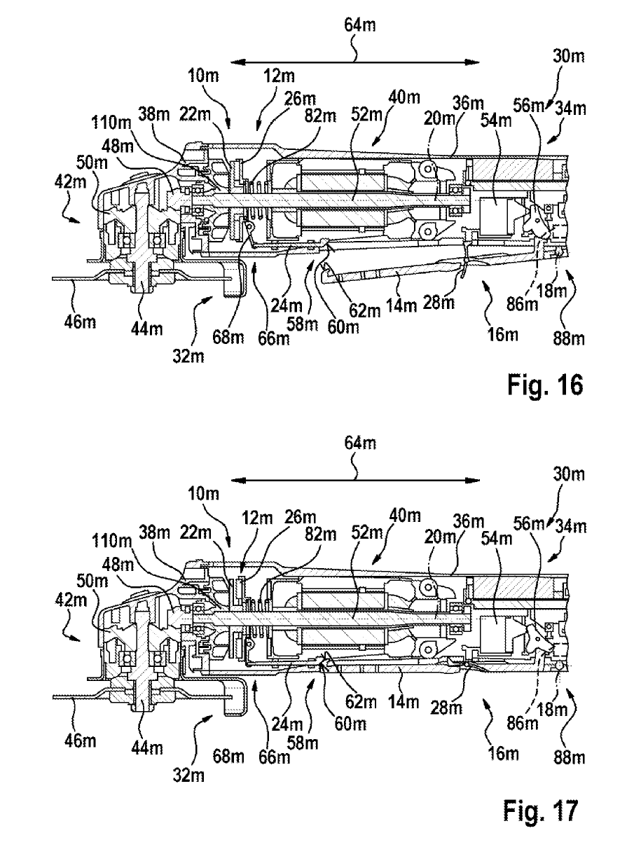

FIG. 16 shows an alternative power tool 30m, having an alternative power tool braking device 10m. The design of the power tool 30m is at least substantially similar to that of the power tool 30a described in FIGS. 1 to 4. The power tool braking device 10m comprises at least one braking unit 12m, and comprises at least one operating unit 16m, having a movably mounted operating element 14m, for activating and/or deactivating the braking unit 12m. The operating element 14m is mounted such that it can pivot about a movement axis 18m of the operating element 14m. The movement axis 18m extends at least substantially transversely in relation to a rotation axis 20m of a rotatably mounted braking element 22m of the braking unit 12m. A pivot bearing region 88m of the operating element 14m in this case is disposed at an end of the operating element 14m that faces away from a transmission housing 38m of a power tool housing 34m of the power tool 30m.

The operating unit 16m has at least one movement coupling element 24m, for coupling the operating element 14m to a counter-braking element 26m of the braking unit 12m. The movement coupling element 24m in this case is mounted in a translationally displaceable manner in the power tool housing 34m. In respect of a movement of the movement coupling element 24m as a result of a movement of the operating element 14m, reference may be made to the description of FIGS. 1 to 4. The movement coupling element 24m is connected to an actuating element 68m of the operating unit 16m, for the purpose of moving a counter-braking element 26m of the braking unit 12m. The actuating element 68m is mounted in the power tool housing 34m such that it can pivot about a movement axis of the actuating element 68m. The movement axis of the actuating element 68m extends at least substantially transversely in relation to the rotation axis 20m of the braking element 22m. In this case, the movement axis of the actuating element 68m, as viewed in a projection plane into which the movement axis of the actuating element 68m and the rotation axis 20m of the braking element 22m are projected, extends at least substantially perpendicularly in relation to the rotation axis 20m of the braking element 22m.

The actuating element 68m is additionally mounted by a link joint on the movement coupling element 24m, in a movement transmission region 66m of the movement coupling element 24m. The actuating element 68m is thus pivotally mounted on the movement coupling element 24m by means of a link joint. The link joint may be realized, for example, by means of a combined action of a pin, or a stud-type extension, and of a recess that corresponds to the pin, or to the stud-type extension, such as, for example, a link eye. The actuating element 68m is connected, by an end that faces away from the movement coupling element 24m, to the counter-braking element 26m. In this case, the end of the actuating element 68m that faces away from the movement coupling element 24m may be movably mounted on the counter-braking element 26m, or the end of the actuating element 68m that faces away from the movement coupling element 24m may engage in a recess, or may bear against an extension of the counter-braking element 26m, for the purpose of moving the counter-braking element 26m against a spring force of a spring element 82m of the braking unit 12m.

The counter-braking element 26m is mounted in the power tool housing 34m so as to be translationally movable along the rotation axis 20m of the braking element 22m. Moreover, the counter-braking element 26m is disposed in a rotationally fixed manner in the power tool housing 34m. Owing to the fact that the counter-braking element 26m is disposed in a rotationally fixed manner in the power tool housing 34m, a rotational movement of the counter-braking element 26m about the rotation axis 20m of the braking element 22m, relative to the power tool housing 34m, is prevented. It is also conceivable, however, for the counter-braking element 26m, as an alternative to being mounted in a translationally movable manner in the power tool housing 34m, to be mounted such that it can pivot about a pivot axis of the counter-braking element 26m that extends at least substantially transversely in relation to the rotation axis 20m of the braking element 22m.

For the purpose of bringing the braking element 22m and/or the counter-braking element 26m out of a braking position and into a release position, an operator actuates the operating element 14m, which is thus moved about the movement axis 18m of the operating element 14m. As a result of a translational movement of the movement coupling element 24m caused by the movement of the operating element 14m, the actuating element 68m is pivoted about the movement axis of the actuating element 68m, because of the link-type connection between the movement coupling element 24m and the actuating element 68m, and because of the pivoted mounting of the actuating element 68m. As a result of the pivot movement of the actuating element 68m and the connection between the actuating element 68m and the counter-braking element 26m, the counter-braking element 26m is moved away from the braking element 22m, against a spring force of the spring element 82m (FIG. 17). The counter-braking element 26m, or the braking element 22m, is thus brought into a release position. After removal of a force, applied by an operator, upon the operating element 14m, and consequently after removal of an action of force upon the movement coupling element 24m and upon the actuating element 68m, the counter-braking element 26m is moved in the direction of the braking element 22m, or pressed on to the braking element 22m, by a spring force of the spring element 82m. The counter-braking element 26m, or the braking element 22m, is thus brought back into a braking position. In respect of further functions and features of the power tool braking device 10m and the power tool 30m, reference may be made to the exemplary embodiment described in FIGS. 1 to 4. In principle, however, it is also conceivable, as an alternative to a movement coupling mechanism described in FIGS. 16 and 17 being used for moving the counter-braking element 26m, for the movement coupling mechanisms described in FIG. 9 to be used, and/or for the design of the operating element 14m to correspond to a design described in FIGS. 5 to 8.

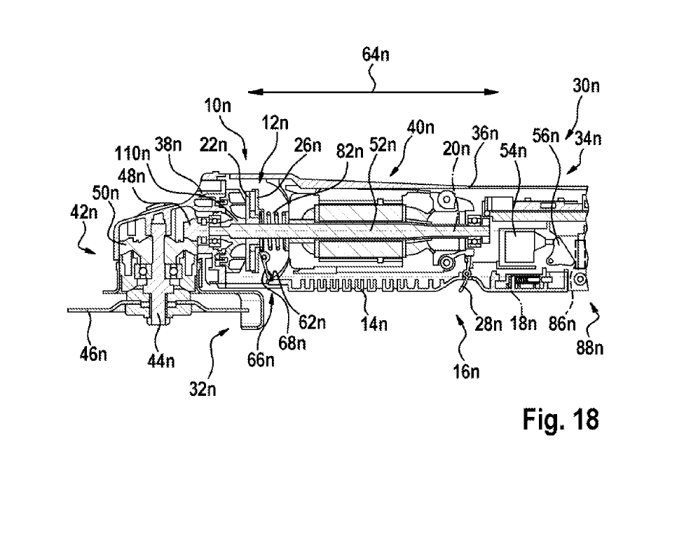

FIG. 18 shows an alternative power tool 30n, having an alternative power tool braking device 10n. The design of the power tool 30n is at least substantially similar to that of the power tool 30a described in FIGS. 1 to 4. The power tool braking device 10n comprises at least one braking unit 12n, and comprises at least one operating unit 16n, having a movably mounted operating element 14n, for activating and/or deactivating the braking unit 12n. The operating element 14n is mounted such that it can pivot about a movement axis 18n of the operating element 14n. The movement axis 18n extends at least substantially parallelwise in relation to a rotation axis 20n of a rotatably mounted braking element 22n of the braking unit 12n. A pivot bearing region 88n of the operating element 14n in this case is disposed at an end of the operating element 14n that faces away from a transmission housing 38n of a power tool housing 34n of the power tool 30n.

For the purpose of activating and/or deactivating the braking unit 12n, the operating element 14n comprises at least one inclined face 62n. The inclined face 62n is disposed on a side of the operating element 14n that faces toward the braking unit 12n. The operating unit 16n additionally comprises at least one actuating element 68n. The actuating element 68n is mounted in the power tool housing 34n such that it can pivot about a movement axis of the actuating element 68n. The movement axis of the actuating element 68n extends at least substantially transversely in relation to the rotation axis 20n of the braking element 22n. In this case, the movement axis of the actuating element 68n, as viewed in a projection plane into which the movement axis of the actuating element 68n and the rotation axis 20n of the braking element 22n are projected, extends at least substantially perpendicularly in relation to the rotation axis 20n of the braking element 22n. The actuating element 68n additionally comprises a movement coupling region, at an end of the actuating element 68n that faces toward the operating element 14n. The movement coupling region of the actuating element 68n in this case may be realized as an inclined face, as a rolling element, etc, that is realized to correspond to the inclined face 62n of the operating element 14n. Thus, for the purpose of moving a counter-braking element 26n of the braking unit 12n, in at least one state, the inclined face 62n bears against the movement coupling region of the actuating element 68n. As a result of this, the actuating element 68n is moved in dependence on a movement of the operating element 14n.

The counter-braking element 26n is mounted in the power tool housing 34n so as to be translationally movable along the rotation axis 20n of the braking element 22n. Moreover, the counter-braking element 26n is disposed in a rotationally fixed manner in the power tool housing 34n. Owing to the fact that the counter-braking element 26n is disposed in a rotationally fixed manner in the power tool housing 34n, a rotational movement of the counter-braking element 26n about the rotation axis 20n of the braking element 22n, relative to the power tool housing 34n, is prevented. It is also conceivable, however, for the counter-braking element 26n, as an alternative to being mounted in a translationally movable manner in the power tool housing 34n, to be mounted such that it can pivot about a pivot axis of the counter-braking element 26n that extends at least substantially transversely in relation to the rotation axis 20n of the braking element 22n.

For the purpose of bringing the braking element 22n and/or the counter-braking element 26n out of a braking position and into a release position, an operator actuates the operating element 14n, which is thus moved about the movement axis 18n of the operating element 14n. In this case, a combined action of the inclined face 62n of the operating element 14n and of the movement coupling region of the actuating element 68n causes the actuating element 68n to be pivoted about the movement axis of the actuating element 86n. As a result of the pivot movement of the actuating element 68n and the connection between the actuating element 68n and the counter-braking element 26n, the counter-braking element 26n is moved away from the braking element 22n, against a spring force of a spring element 82n of the braking unit 12n. The counter-braking element 26n, or the braking element 22n, is thus brought into a release position. After removal of a force, applied by an operator, upon the operating element 14n, and consequently after removal of an action of force upon the actuating element 68n, the counter-braking element 26n is moved in the direction of the braking element 22n, or pressed on to the braking element 22n, by a spring force of the spring element 82. The counter-braking element 26n, or the braking element 22n, is thus brought back into a braking position. In respect of further functions and features of the power tool braking device 10n and the power tool 30n, reference may be made to the exemplary embodiment described in FIGS. 1 to 4. In principle, however, it is also conceivable, as an alternative to a movement coupling mechanism described in FIG. 18 being used for moving the counter-braking element 26n, for the movement coupling mechanisms described in FIGS. 9 to 15 be used, and/or for the design of the operating element 14n to correspond to a design described in FIGS. 5 to 8.

1. A power tool braking device, comprising:
at least one braking unit; and
at least one operating unit having a movably mounted operating element configured to one or more of activate and deactivate the braking unit, the operating element having a movement axis and being mounted such that the operating element is configured to pivot about the movement axis.

2. The power tool braking device as claimed in claim 1, wherein the braking unit includes a rotatably mounted braking element, and wherein the movement axis of the operating element extends at least substantially transversely in relation to a rotation axis of the rotatably mounted braking element.

3. The power tool braking device as claimed in claim 1, wherein the braking unit includes a rotatably mounted braking element, and wherein the movement axis of the operating element extends at least substantially parallelwise in relation to a rotation axis of the rotatably mounted braking element.

4. The power tool braking device as claimed in claim 1, wherein the braking unit includes a counter-braking element, and wherein the operating unit has at least one movement coupling element that is configured to couple the operating element to the counter-braking element.

5. The power tool braking device as claimed in claim 1, wherein the braking unit includes a counter-braking element, and wherein the operating unit has at least one movement coupling element formed as a cable pull element that is configured to couple the operating element to the counter-braking element.

6. The power tool braking device as claimed in claim 1, wherein the braking unit includes a counter-braking element, and wherein the operating unit has at least one movement coupling element formed as a rack element that is configured to couple the operating element to the counter-braking element.

7. The power tool braking device as claimed in claim 1, wherein the braking unit includes a counter-braking element, and wherein the operating unit has at least one movement coupling element formed as a rotary lever element that is configured to couple the operating element to the counter-braking element.

8. The power tool braking device as claimed in claim 1, wherein the operating unit comprises at least one switch-on blocking element that is connected to a movement coupling element of the operating unit.

9. The power tool braking device as claimed in claim 1, wherein the operating unit comprises at least one switch-on blocking element that is mounted such that the switch-on blocking element is configured to pivot on the operating element.

10. A power tool, comprising:
at least one power tool braking device including:
at least one braking unit; and
at least one operating unit having a movably mounted operating element configured to one or more of activate and deactivate the braking unit, the operating element having a movement axis and being mounted such that the operating element is configured to pivot about the movement axis.

11. The power tool braking device as claimed in claim 1, wherein the power tool braking device is configured as a hand-held power tool braking device.

12. The power tool as claimed in claim 10, wherein the power tool is configured as an angle grinder.
